(19) United States
(12) Patent Application Publication
(10) Pub. No.: US 2021/0059220 A1
(43) Pub. Date: Mar. 4, 2021

(54) TEST ENVIRONMENT FOR THE CHARACTERIZATION OF NEUROPATHIC PAIN

(71) Applicant: Children`s Medical Center Corporation, Boston, MA (US)

(72) Inventors: Michael Costigan, Cambridge, MA (US); Rafael Gonzalez-Cano, Cambridge, MA (US); Yildirim Ozdemir, Boston, MA (US)

(21) Appl. No.: 17/003,518

(22) Filed: Aug. 26, 2020

Related U.S. Application Data
(60) Provisional application No. 62/892,002, filed on Aug. 27, 2019.

(51) Int. Cl. A01K 29/00; G06T 7/00; G06K 9/00

(52) U.S. Cl. CPC A01K 29/005; G06K 9/00342; G06T 7/00

(57) ABSTRACT

A method for characterization of mechanically induced pain experienced by an animal includes exposing the animal to an environment including a first region having a planar surface and a second region having a chainmail structure; characterizing an interaction of the animal with one or more of the first region of the environment and the second region of the environment; and determining a characterization of tactile hypersensitivity experienced by the animal based on the characterization of the interaction of the animal with one or more of the first and second regions of the environment.

### CLAIM OF PRIORITY

This application claims priority to U.S. Patent Application Ser. No. 62/892,002, filed on Aug. 27, 2019, the contents of which are incorporated here by reference in their entirety.

### BACKGROUND

Pathological changes in the peripheral nervous system or the central nervous system that create chronic pain often lead to altered sensory signaling, which can present as spontaneous pain with no apparent stimulus. Such pain can manifest as a loss of sensation (felt as numbness) or as hypersensitivity to normally noxious stimuli (referred to as hyperalgesia) or to previously innocuous stimuli (allodynia). Tactile allodynia, which is pain elicited by touch, is a prominent complaint in patients of both neuropathic pain and chronic inflammation. Tactile allodynia can be measured using calibrated evoked stimuli such as von Frey monofilaments or a Dynamic Plantar Aesthesiometer, which is an electronic version of the von Frey filaments.

### SUMMARY

In an aspect, a method for characterization of mechanically induced pain experienced by an animal includes exposing the animal to an environment including a first region having a planar surface and a second region having a chainmail structure; characterizing an interaction of the animal with one or more of the first region of the environment and the second region of the environment; and determining a characterization of tactile hypersensitivity experienced by the animal based on the characterization of the interaction of the animal with one or more of the first and second regions of the environment.

Embodiments can include one or more of the following features.

Determining a characterization of the mechanically induced pain experienced by the animal includes quantitatively characterizing the tactile hypersensitivity experienced by the animal.

The method includes providing the environment, including providing a chainmail hammock for the second region.

Characterizing an interaction of the animal includes determining an amount of time spent by the animal in the second region.

Characterizing an interaction of the animal includes capturing a video of the interaction of the animal with each of the first region and the second region. Characterizing the interaction includes analyzing the captured video to characterize one or more behaviors of the animal. Analyzing the captured video includes characterizing a grooming behavior of the animal. The method includes analyzing the video using a predictive analytics algorithm, based on animal behavior patterns.

Characterizing an interaction of the animal includes characterizes a change in the interaction over a duration of the animal's exposure to the environment.

Characterizing an interaction of the animal includes characterizing one or more of a speed and a direction of the animal's movement in the second region.

In an aspect, a method for screening treatments for tactile hypersensitivity includes sequentially exposing each of multiple animals in an injury group to an environment including a first region having a planar surface and a second region having a chainmail structure; characterizing an average interaction of the animals in the injury group with one or more of the first region of the environment and the second region of the environment; and treating each of multiple animals in a treatment group with a potential treatment for mechanically induced pain, in which the animals in the treatment group experience mechanical hypersensitivity; sequentially exposing each of the treated animals in the treatment group to the environment; characterizing an average interaction of the treated animals in the treatment group with one or more of the first region of the environment and the second region of the environment; and determining an effectiveness of the potential treatment based on a comparison between the average interaction of the animals in the injury group and the average interaction of the treated animals in the treatment group.

In an aspect, a system for characterization of neuropathic pain experienced by an animal includes an enclosed test environment having a first region and a second region adjacent the first region, the first region having a planar surface, and the second region having a chainmail structure; one or more cameras positioned such that the entire first region and the entire second region are in a field of view of the one or more cameras; and a computing device including one or more processors coupled to a memory and configured to analyze images obtained by the one or more cameras and to determine a characterization of neuropathic pain experienced by an animal in the enclosed test environment based on the analysis of the images.

Embodiments can include one or more of the following features.

The chainmail structure includes a chainmail hammock.

The enclosed testing environment has a third region including a cold plate.

The third region is adjacent the first region.

The one or more processors are configured to apply a predictive analytics algorithm in the analysis of the images.

The approaches described here for characterizing chronic pain in an animal can have one or more of the following advantages. The structure of the chainmail hammock does not allow the animal to compensate for its injured paw, preventing the animal from preventing unwanted painful tactile input by guarding the injured paw and so contributing to the accuracy of the test. The test can be conducted without a highly trained administrator, and data collection and analysis can be automated, making the test efficient and inexpensive, e.g., enabling low-cost treatment screening. The relative lack of human involvement makes the testing objective and not subject to human error or operator bias, meaning that the tests can produce replicable, accurate data from a lightly trained experimenter. The testing environment is scalable and the tests can be performed with high throughput and without need for calibration procedures.

### BRIEF DESCRIPTION OF DRAWINGS

FIG. 1 is a side view diagram of a testing environment.

FIGS. 2A and 2B are perspective and side view diagrams, respectively, of a chainmail hammock.

FIGS. 3 and 4 are flow charts.

FIG. 5 is a side view diagram of a testing environment with two alternate planar surfaces (set at different temperatures).

FIG. 6 is a plot of the percentage of time spent on a chainmail hammock for spared nerve injury (SNI) mice and sham control mice.

FIG. 7 is a plot of results obtained on the chainmail sensitivity test and using von Frey filaments on the same animals. Data from SNI and sham control mice shown.

FIG. 8 is a plot of the percentage of time spent on the chainmail sensitivity test for SNI mice and sham control mice treated with the anti-neuropathic drug Gabapentin.

FIG. 9 is a plot of the percentage of time spent on a chainmail hammock for SNI mice and sham control mice treated with a nonsteroidal anti-inflammatory drug ibuprofen.

FIG. 10 is a plot of the percentage of time spent on a chainmail hammock for incised paw mice and naïve control mice.

FIG. 11 is a plot of the percentage of time spent on a chainmail hammock for mice with carrageenan inflamed paws and saline injected control mice.

### DETAILED DESCRIPTION

We describe here a testing environment that can be used to conduct sensitivity tests to characterize neuropathic pain, such as tactile allodynia, in test animals such as rodents. The testing environment includes two regions: a region that is expected to induce pain in an animal suffering from neuropathic pain, and a region that is expected not to induce pain in the animal. The animal is allowed to explore the testing environment. A qualitative or quantitative characterization of the tactile hypersensitivity experienced by the animal can be determined based on the animal's interaction with the testing environment, such as a percentage of the total test time spent by the animal in the region that is expected to induce pain.

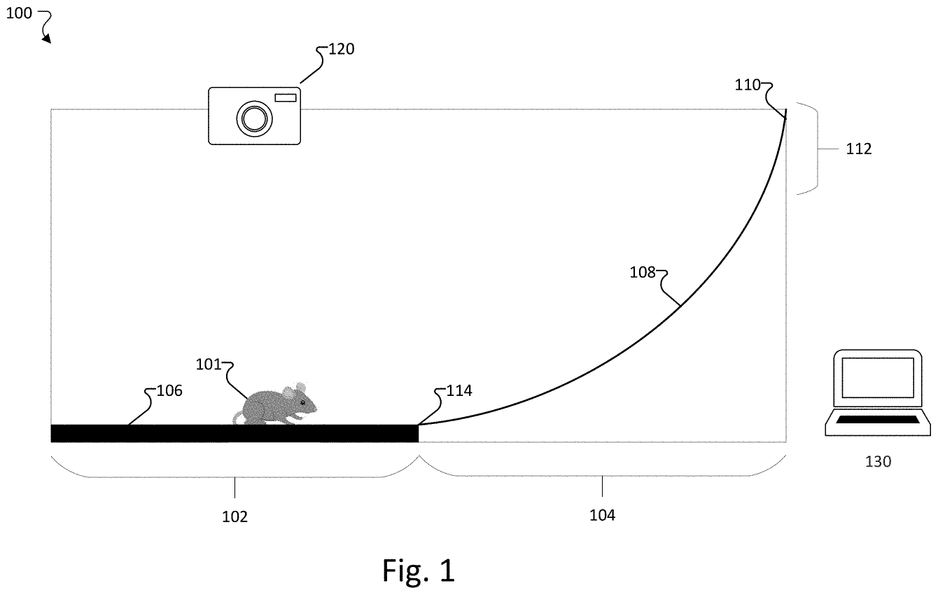

Referring to FIG. 1, a testing environment 100 is used for conducting sensitivity tests to characterize neuropathic pain in test animals 101 such as rodents, e.g., mice. The testing environment 100 provides multiple regions with which a test animal in the testing environment 100 can interact. A qualitative or quantitative characterization of the mechanically induced pain experienced by the test animal can be determined based on analysis of the test animal's interactions with the testing environment 100, e.g., the amount of time the animal spends in each of the multiple regions or the animal's activities within each region.

The testing environment 100 is an enclosed environment in which two adjacent regions are defined: a first region 102 and a second region 104. The first region 102 (sometimes referred to as the control region) has a planar, rigid surface 106 that is configured to cause little to no pain in the test subject when the test subject walks on the surface 106. For instance, the surface 106 can be a floor made of metal, wood, rigid plastic, or another rigid material. The second region 104 (sometimes referred to as the testing region) includes a structure 108 that is configured to provide a stimulus that causes painful hypersensitivity in a test animal suffering from neuropathic pain. When the test animal interacts with (e.g., walks or climbs on) the structure, the animal's interaction with the structure induces tactile allodynia in a hind paw of the injured animal. For instance, the structure 108 can be made of a mesh that is inclined relative to the solid surface 106 of the first region 102. The mesh can be a flexible mesh (akin to a rope climbing net), e.g., made of nylon or another type of flexible material. The mesh can be a chainmail material. The second testing region 104 is sometimes referred to as the chainmail region and the structure 108 referred to as a chainmail hammock; however, it is to be understood that the terms chainmail region and chainmail hammock encompass other types of mesh structures.

A first end 110 of the chainmail hammock 108 is secured to an upper area 112 of the testing environment, such as a top corner. In some examples, a second end 114 of the chainmail hammock 108 is affixed to an edge of the surface 106 of the first region; in some examples, the second end 114 of the chainmail hammock is free. The chainmail hammock 108 can hang freely from its first end 110 even when the second end 114 of the chainmail hammock 108 is affixed to the surface 106 of the first region, e.g., such that the chainmail hammock 108 can undergo some motion when the test subject climbs on the hammock 108.

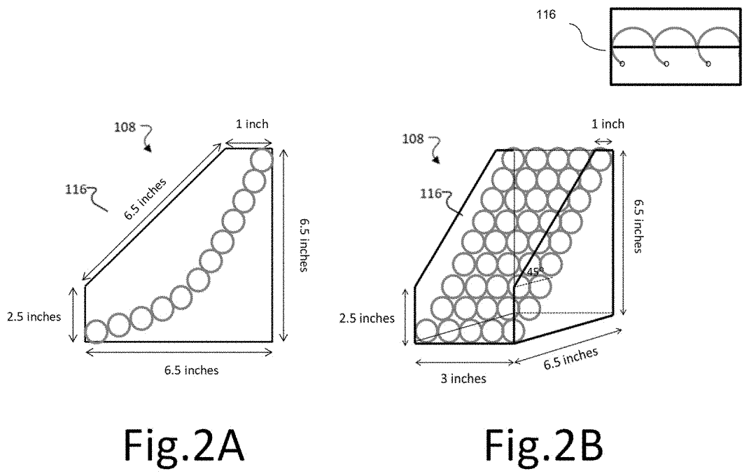

FIGS. 2A and 2B show an example of a chainmail hammock 108. By chainmail, we mean a material that is formed of interlocking rings 116, such as rigid rings (e.g., metal or rigid plastic rings) or flexible rings (e.g., nylon or flexible plastic rings). In the context of a testing environment for a rodent, the rings 116 can be sized such that a hind paw of the test animal can fit inside the rings 116, e.g., such that the animal can climb up the chainmail hammock 108 by stepping into the rings 116. By a chainmail hammock, we mean that the chainmail material is secured at its top and hangs at least partially freely from the top, such that the chainmail hammock can sway or sag when the animal climbs on it. In some examples, the chainmail hammock 108 can also be secured at its bottom such that the chainmail hammock 108 hangs loosely between the top and bottom. In the example of FIG. 2, the chainmail hammock 108 is secured to the upper area 112 of the testing environment and the surface 106 of the first region by holes that receive the rings 116 of the chainmail are inserted. Other approaches to securing the chainmail hammock 108 can also be employed.

During a sensitivity test, the test animal is placed into the enclosed testing environment 100 and allowed to roam freely around both the first region 102 and the second region 104. The interaction of the test animal with the first and second regions 102, 104 can differ depending on whether or not the animal suffers from hypersensitivity in a hind paw, e.g., mechanically induced pain derived from a nerve injury, paw inflammation, or tissue injury in the paw. In particular, as described further below, a neuropathic test animal is likely to precipitate pain when climbing on the chainmail hammock 108, and thus is likely to spend less time on the chainmail hammock 108 than an animal that does not suffer from this painful sensation. The interactions of the test animal with the first and second regions 102, 104 of the testing environment 100 can be used to determine a qualitative or quantitative characterization of the neuropathic pain experienced by the animal.

A test animal that does not suffer from mechanically induced pain tends to explore the entire testing environment 100, e.g., prompted by its natural curiosity to explore new environments (both region 102 and the chainmail hammock 108 of region 104). Exploration of the chainmail hammock 108 causes little to no discomfort to such an animal, and so the animal is likely to spend an appreciable amount of time on the chainmail hammock 108, e.g., between about 40% and about 60% of the total test time, e.g., about 50% of the total test time. A test animal that suffers from hypersensitivity in its hind paw, however, is likely to experience mechanically induced pain when climbing on the chainmail hammock 108. Without being bound by theory, it is believed that this pain is because climbing on the chainmail hammock 108 causes the test animal to place weight on its hind paws, inducing tactile input and therefore creating pain. Furthermore, the somewhat free movement of the chainmail hammock 108 makes it difficult for the animal to guard its paw to compensate for this uncomfortable pressure. To avoid this pain, the animal will tend to spend less time on the chainmail hammock 108, despite the animal's natural curiosity and desire to explore. Instead, the animal will spend more time on the planar surface of the second region 104, where the animal is able to guard its paw. For instance, the animal is likely to spend less than 50% of the total test time on the chainmail hammock, e.g., less than 40%, less than 30%, or less than 20% of the total test time.

The relative amounts of time a test animal spends in the first and second regions 102, 104 (e.g., a ratio of the times or a percentage of time spent in one of the regions) can be regarded as a proxy for a degree of mechanically induced pain experienced by the animal. For instance, an animal that suffers from neuropathic pain is likely to spend less time on the chainmail hammock 108 than an animal that does not suffer from neuropathic pain. Other interactions of the test animal with the first and second regions can also be indicators of the degree of neuropathic pain experienced by the animal. Examples of such interactions can include a path taken by the animal up or down the chainmail hammock, a speed at which the animal descends the chainmail hammock, a most frequent location of the animal on the chainmail hammock or on the surface 106 of the first region, a grooming behavior of the animal, or other interactions. These interactions can be analyzed by a predictive analytics computing system to determine a characterization of the mechanically induced pain experienced by the test animal, as discussed below.

The testing environment 100 can include a video camera 120 to capture video of the sensitivity test. The captured video can be analyzed, e.g., in real time or after the sensitivity test, to determine a quantitative measure of the neuropathic pain experienced by the test animal. For instance, the captured video can be analyzed to quantify the relative amounts of time spent by a test animal in each of the first and second regions 102, 104. In some examples, the captured video can be analyzed by a computing system 130, e.g., a computing system 130 implementing a predictive analytics approach to behavior analysis.

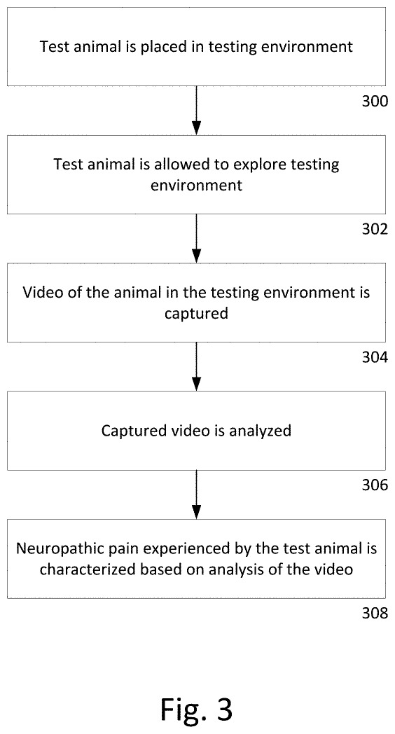

Referring to FIG. 3, in an example procedure for a sensitivity test, a test animal, such as a mouse, is placed in a testing environment (300) having a first region including a planar, rigid surface and a second region including a chainmail hammock. The animal is allowed to explore the testing environment for a specific amount of time (302), e.g., a predefined amount of time, or for an amount of time until a stopping criterion is achieved, such as the animal becomes tired or bored. During the sensitivity test, video of the animal in the testing environment is captured (304).

During or after the sensitivity test, the captured video is analyzed (306), e.g., by an automated computing system, to determine a qualitative or quantitative characterization of mechanically induced pain experienced by the animal (308). For instance, the percentage of time spent by the animal on the chainmail hammock can be determined by analysis of the captured video. Other interactions of the animal with the testing environment can also be determined by analysis of the captured video and used to characterize the level of hypersensitivity experienced by the animal. Examples of such interactions can include a path taken by the animal up or down the chainmail hammock, a speed at which the animal descends the chainmail hammock, a most frequent location of the animal on the chainmail hammock or on the surface 106 of the first region, a grooming behavior of the animal, or other interactions. These interactions can be analyzed by a predictive analytics computing system to determine a characterization of the tactile hypersensitivity experienced by the test animal, as discussed below.

In some examples, the testing environment can be used for screening potential treatments for neuropathic pain. For instance, a treatment group of test animals that suffer from neuropathic pain and a control group of test animals that do not suffer from neuropathic pain can both be treated with a potential treatment, and a sensitivity test carried out for each test animal. The interactions of the test animals in the treatment group with the two regions of the testing environment can be compared to the interactions of the test animals in the control group to evaluate the effectiveness of the potential treatment. For instance, a group of test animals known to be suffering from neuropathic pain can be treated with a potential treatment, and the interactions of the treated animals with the testing environment can be analyzed to determine whether the potential treatment had an effect.

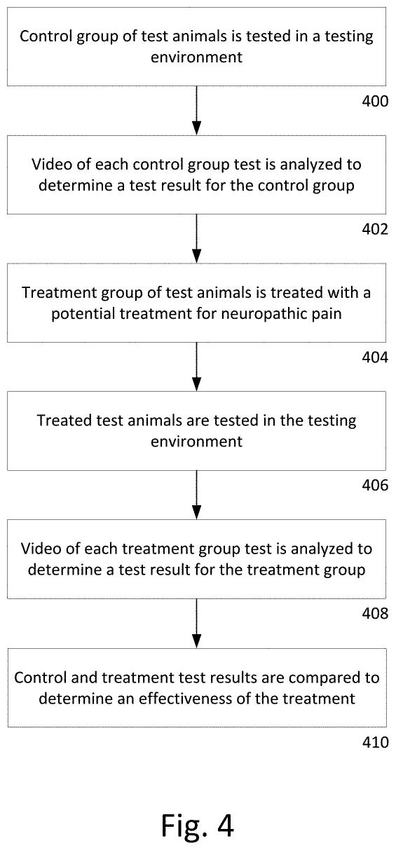

FIG. 4 shows an example process for screening potential treatments for tactile allodynia using a testing environment such as that shown in FIG. 1. A control group of test animals, such as mice, are tested individually in the testing environment (400). The control group can include healthy mice, mice subjected to a sham injury (e.g., tissue dissection), or mice known to be suffering from neuropathic pain. Sometimes the control group can also be referred to as the injury group, e.g., when the control group includes mice subjected to a sham injury or mice known to be suffering from neuropathic pain. The testing can include allowing each animal to explore the testing environment for an amount of time during which video of the animal is captured. The video of each test is analyzed to determine a test result for the control group, such as an average percentage of the total test time spent on the chainmail hammock by the animals in the control group (402).

A treatment group of test animals known to be experiencing neuropathic pain is treated with a potential treatment (404), such as a pharmaceutical treatment, a physical therapy treatment, or another type of treatment. The treated animals are tested individually in the testing environment (406), including allowing each animal to explore the testing environment while video of the animal is captured. The video of each test is analyzed to determine a test result for the treated group, such as an average percentage of the total test time spent on the chainmail hammock by the treated animals (408).

The test result for the control group is compared to the test result for the treated group to determine an effectiveness of the treatment (410). For instance, if the control group includes healthy mice and if the treated mice spent on average the same percentage of total test time on the chainmail hammock as the control mice, the treatment may be evaluated as being effective. If the control group includes untreated mice suffering from tactile allodynia and if the treated mice spent on average a larger percentage of total test time on the chainmail hammock as the control mice, the treatment may be evaluated as being effective.

In some examples, a similar approach can be followed to evaluate dosage effects, e.g., by evaluating groups of test animals having been treated with different doses of a potential treatment.

In some examples, the testing environment and sensitivity tests described here can be used to test types of mechanically induced sensitivity other than neuropathic tactile pain. For instance, these approaches can be used to qualitatively or quantitatively characterize mechanical hypersensitivity induced in procedural pain models, such as from incisions (surgery for instance) or local injury, or inflammatory pain models.

In some examples, the computing system for analyzing the video of a test can employ a predictive analytics approach. For instance, raw data, such as the video or an initial analysis of the video, can be provided as input into computer learning algorithms. The learning algorithms can search for and quantify behavioral patterns that may be predictive of neuropathic pain or of other types of pain, such as procedural pain or inflammatory pain. For instance, the learning algorithms can identify behaviors that are predictive of a certain type of pain, such as a path taken by the animal up or down the chainmail hammock (e.g., the animal moving directly up and down the hammock or wanders may indicate discomfort), a speed at which the animal descends the chainmail hammock (e.g., an animal that descends quickly may be in pain), a most frequent location of the animal on the chainmail hammock or on the surface of the first region (e.g., an animal that stays in a corner may be an anxious animal), a grooming behavior of the animal (e.g., grooming may be indicative of discomfort), or other interactions.

Employing an analysis that takes into account these learned behavioral patterns can enable these behaviors to be identified during or after a test and to be used in the qualitative or quantitative characterization of the pain hypersensitivity experienced by a test animal.

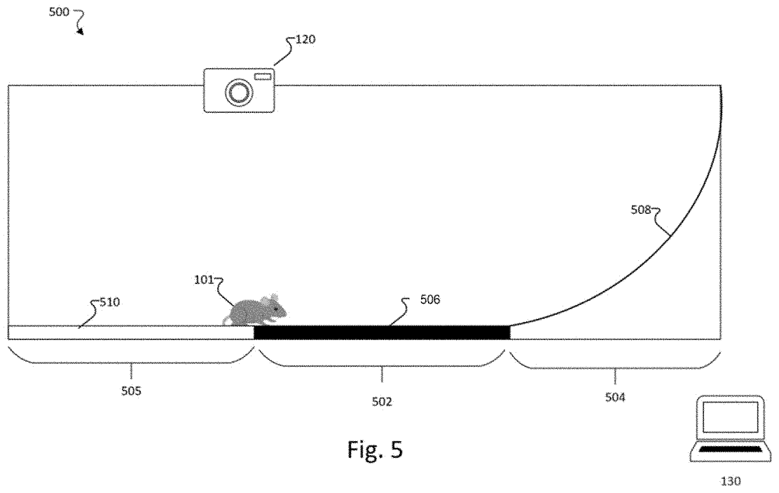

Referring to FIG. 5, in an example, a testing environment 500 can enable testing for both tactile allodynia and cold allodynia in a test animal 101. Cold allodynia is a painful sensitivity to cold stimuli. Three regions 502, 504, 505 are defined in a testing environment 500. The first region 502 can include a planar, rigid surface 506 (akin to the surface 106 of the first region shown in FIG. 1) at room temperature and is designed to evoke little to no hypersensitivity in an animal suffering from neuropathic pain. The second region 504 can include a chainmail hammock 508 or other structure designed to evoke pain in an animal suffering from neuropathic pain. The third region 505 can include a cold plate 510 that cools a top surface of the third region, e.g., to a temperature of at least 10° below room temperature. In the example of FIG. 5, the first region 502 is disposed between the second and third regions 504, 505. Other arrangements of the regions are also possible. Video features are as described with respect to FIG. 1. The interactions of a test animal in the testing environment 500 can enable qualitative or quantitative characterization of both tactile and cold allodynia experienced by the animal. Such data could be used separately or combined to give a composite neuropathic allodynia score.

### EXAMPLES

Experiments were performed using the testing environment shown in FIG. 1 to explore the ability of chainmail sensitivity tests to characterize mechanically induced pain in rodents. The experiments demonstrated the ability of such tests to be used for treatment screening. The experiments also demonstrated that chainmail sensitivity tests can characterize various types of pain, including neuropathic pain, procedural pain, and inflammatory pain.

Male adult C57BL/6 mice were characterized using a testing environment such as that shown in FIG. 1, having a first region with a planar metal floor adjacent to a second region with a chainmail hammock. Injured and control mice were placed individually in the first region and allowed to freely roam the entire testing environment for 30 minutes. During this period, the mice were videoed using a camera mounted above the testing environment. Each chainmail sensitivity test was performed on at least two independent cohorts of mice, and the data were checked for consistency and then merged.

Mice were not habituated to the testing environment prior to conducting a sensitivity test because it was observed that they become accustomed to the testing environment relatively quickly. This habituation can lead to the control mice spending less time on the chainmail hammock than they would without habituation. In the experiments described here, the control mice were tested a maximum of two times using the testing environment to avoid habituation to the testing environment.

### Example 1—Characterization of Tactile Allodynia with a Chainmail Sensitivity Test

Mice having a spared nerve injury (SNI) were tested in a chainmail sensitivity test using a testing environment such as that shown in FIG. 1 to characterize the neuropathic tactile allodynia experienced by the mice. To induce peripheral nerve injury, mice were anesthetized with 2% isoflurane (vol/vol) at 6-8 weeks old and SNI surgery was performed. The tibial and common peroneal braches of the sciatic nerve were tightly ligated with a silk suture and transected distally; the sural nerve was left intact. As a control, sciatic nerve transection (axotomy) was performed on some mice instead of an induced peripheral nerve injury. In an axotomy, the left sciatic nerve was exposed at the mid-thigh level, ligated with silk, and sectioned distally. Sham control mice were not subjected to either nerve injury but did undergo surgery to the peripheral tissue of the hindpaw.

Mice were assayed using a chainmail sensitivity test one week post nerve injury, at a point where tactile allodynia had fully developed in the SNI mice. Sham control mice were also assayed using the chainmail sensitivity test to observe the difference in the average percentage of time each group of mice spent on the chainmail hammock.

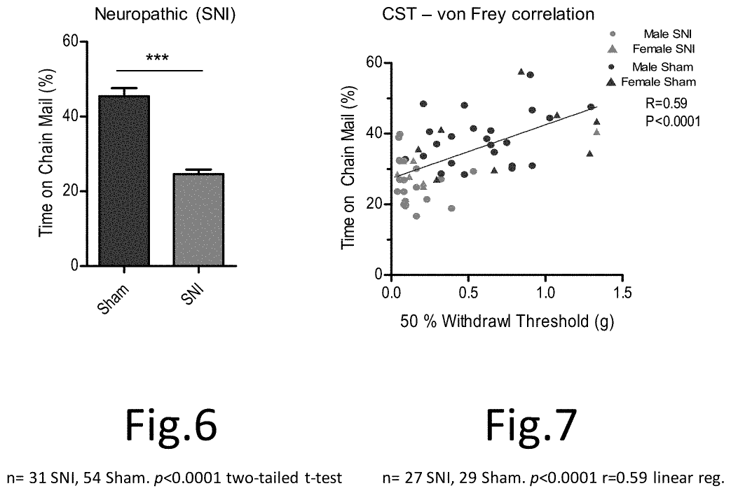

The percentage of the total assay time spent on the chainmail hammock was measured for 31 SNI mice and 53 sham control mice. Referring to FIG. 6, SNI mice were significantly less likely to spend time on the chainmail hammock than sham control mice. The SNI average percentage of time on the chainmail hammock was 24.6±1.3%, as compared to 45.4±2.1% for sham control mice. The p-value was 6.4E-10. These results indicate that SNI mice spend significantly less time on the chainmail hammock than uninjured mice, demonstrating the potential for the testing environment to be used for characterization of tactile allodynia.

To control for the possibility that SNI mice do not climb on the chainmail hammock because of a lack of motor control brought on by the spared nerve injury, mice subjected to a full scale sciatic nerve axotomy were assayed with the sensitivity test. Fully axotomized mice lack any sensation within the denervated paw, as no intact sensory axons remain within the peripheral tissue. In addition, motor control is profoundly affected by an axotomy, with little or no movement possible in the axotomized limb distal to the nerve injury. SNI mice retain some innervation from the spared sural nerve which, with respect to the sensory system, is responsible for the tactile allodynia present and within the motor system, minimal retained control of movement.

Mice exposed to complete axotomy of the sciatic nerve spent 41.9±5.5% of assay time on the chainmail hammock, as compared to sham control mice 42.1±3.5% of assay time (p-value=0.98, two-tailed t-test, n=8-12). These data are not significantly different, but are different to the time percentages for SNI mice (e.g., FIG. 6). These results validate the hypothesis that the lack of motor control (brought on by the nerve axotomy injury) plays little to no role in the region the mice choose to explore during the test.

To confirm that differences in the time spent on the chainmail hammock between SNI mice and sham control mice can be used for accurate quantitative characterization of tactile allodynia in the injured hind paw, the same group of mice was assayed with the chainmail sensitivity test and using the von Frey method for determining tactile sensitivity.

Mechanical allodynia was measured using von Frey filaments (Touch-Test Sensory Evaluators; North Coast Medical, Inc, Gilroy, Calif.). Tactile sensitivity was measured at 7 days post SNI. Filaments ranged from 0.02, 0.04, 0.07, 0.16, 0.4, 0.6, 1.0, and 2.0 grams. Beginning with the 0.6 gram filament, pressure was applied to the left hind paw three times, with 10 second intervals between each application. Depending on whether a response was elicited (brisk paw withdrawal and/or an escape attempt), a stronger or weaker filament was then used, following the up-down method (reference PMID: 29765323).

FIG. 7 shows the correlation between the percentage of assay time spent on the chainmail hammock during a chainmail sensitivity test and tactile sensitivity for SNI mice and sham control mice determined by the von Frey method. The graph shows good correlation between these two testing approaches, with a p-value of less than 0.0001 and an r value for the best fit slope line of 0.59 (n=54). It is generally accepted that von Frey monofilament thresholds represent an accurate quantification of tactile sensitivity. For mice subject to partial sciatic nerve injury, the hypersensitivity present in the paw innervated by the remaining axons represents a reliable measure of stimulus evoked tactile allodynia. The positive correlation shown in FIG. 7 between time spent on the chainmail hammock and the von Frey measures across multiple individual mice indicates that the chainmail sensitivity test is able to accurately quantify evoked tactile hypersensitivity.

### Example 2—Treatment Screening

Chainmail hammock sensitivity tests were performed using a testing environment such as that shown in FIG. 1 to screen the effectiveness of two commonly used analgesics, gabapentin and ibuprofen, as potential treatments for tactile allodynia.

Gabapentin is a first line anti-neuropathic agent in humans and can also be an effective drug to relieve chronic neuropathic hypersensitivity in rodents. Experiments were conducted to explore the ability of gabapentin to reduce the reticence of 7 day post-SNI mice to explore the chainmail hammock in the testing environment. Weight-dependent volumes of gabapentin doses at 60, 30, and 15 mg/kg were injected into both SNI mice and sham control mice one hour before testing. Control mice (0 dose of gabapentin) were sham and SNI animals (p<0.0001, two-tailed t-test, n=13 SNI, 15 Sham).

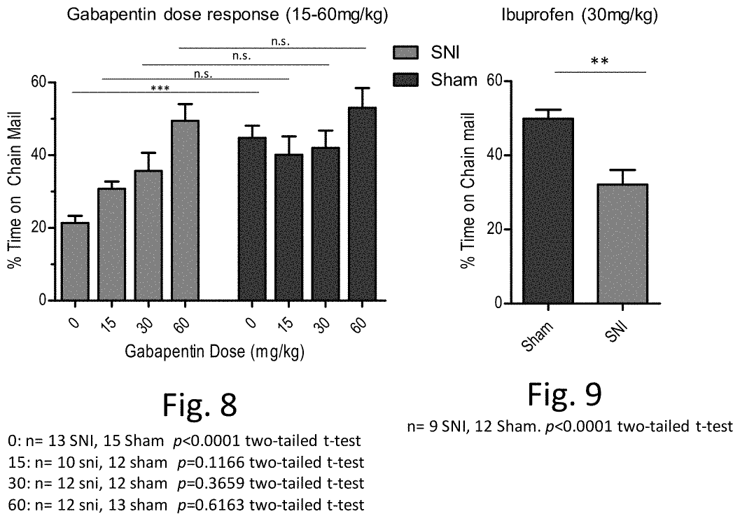

Referring to FIG. 8, at gabapentin doses of 15 mg/kg, 30 mg/kg and 60 mg/kg, gabapentin-treated SNI mice exhibited analgesia which reduced the difference in time spent on the chainmail by these mice relative to gabapentin-treated sham control mice. At a gabapentin dose of 15 mg/kg, SNI mice spent 30.8±1.9% of assay time versus 40.1±4.8% for sham control mice (not significant, two-tailed t-test, n=10 SNI, 12 Sham). At a gabapentin dose of 30 mg/kg, SNI mice spent 35.7±4.8% of assay time versus 42.0±4.5% for sham control mice (not significant, two-tailed t-test, n=12 SNI, 12 Sham). At a gabapentin dose of 60 mg/kg, SNI mice spent 49.5±4.4% of assay time versus 53.1±5.2% for sham control mice (not significant, two-tailed t-test, n=12 SNI, 13 Sham).

These data indicate that gabapentin treatment has a significant effect on the percentage of assay time spent on the chainmail hammock. Because the percentage of time spent by a mouse on the chainmail hammock can be a proxy for the tactile allodynia experienced by the mouse, these results thus suggest that gabapentin can reduce the effects of tactile allodynia to the point where a mouse suffering from tactile allodynia has a similar behavior as an uninjured mouse. These results also indicate that the chainmail sensitivity test can operate with a high degree of sensitivity in that the results distinguish analgesic effects of gabapentin at 15 mg/kg, 30 mg/kg and 60 mg/kg in a dose responsive manner.

Ibuprofen is a first line non-steroidal anti-inflammatory drug widely used in clinical settings and over-the-counter settings to relieve normo-acute pain, such as transient headaches or acute tissue injury or infection, procedural pain, and chronic inflammatory pain. Ibuprofen is not generally considered to be an effective analgesic for neuropathic pain. Experiments were conducted to assess the effectiveness of ibuprofen in reducing the reticence of 7 day post-SNI mice to explore the chainmail hammock. 30 mg/kg ibuprofen was administered to both SNI-injured and sham control mice.

Referring to FIG. 9, ibuprofen-treated SNI mice spent 32.12±3.4% of assay time in the chainmail region, significantly less than ibuprofen-treated sham control mice which spent 49.90±2.25% on the chainmail (p-value <0.005, two-tailed t-test, n=9 SNI, 12 Sham). This result demonstrates that SNI induced hypersensitivity was not fully reversed by Ibuprofen administration given at a standard anti-inflammatory dose (30 mg/kg). However, SNI mice treated with Ibuprofen (32.12±3.4%, FIG. 9) displayed a slight but statistically significant increase in the time spent in the chainmail region relative to untreated SNI mice (24.57±1.30%, FIG. 6, p-value <0.05, two-tailed t-test). These data point to a minor anti-inflammatory action of this NSAID. Without being bound by theory, it is believed that this overall loss in hypersensitivity within the Ibuprofen experiments (FIG. 9) may be due to the anti-inflammatory actions of ibuprofen on peripheral tissue injuries due to the surgery to which both experimental groups were exposed.

### Example 3—Other Characterizations

Chainmail sensitivity tests were performed for mice subject to a paw incision and mice suffering from inflammatory tactile hypersensitivity to explore the ability of such tests to characterize types of tactile pain other than neuropathic allodynia.

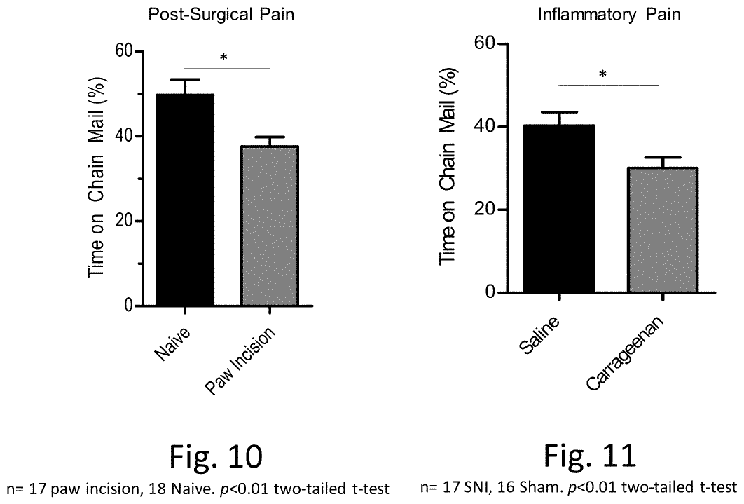

Paw incision mice and control naïve mice were assayed using the Chainmail Sensitivity Test to explore the ability of the testing environment to characterize mechanical sensitivity in the paw of mice subject to procedural pain (from the paw incision). To prepare incised paw mice, mice were anesthetized with 2% isoflurane (vol/vol) at 9 weeks. The left hind paw was sterilized and underlying muscle was cut along the midline using a number-11 scalpel from the base of the heel to the first walking pad. The overlying skin was sutured using 6-0 sutures (Ethilion®, Ethicon, Johnson & Johnson Medical N.V., Belgium). Referring to FIG. 10, incised paw mice spent 37.6±2.2% of the assay time on the chainmail versus (49.7±3.6% for naïve mice, p-value <0.01, two-tailed t-test, n=17 incision, n=18 naïve). These data demonstrate that the percentage of time spent on the chainmail hammock can characterize mechanical hypersensitivity due to peripheral tissue damage.

Mice subject to carrageenan induced inflammation and control mice were assayed using the Chainmail Sensitivity Test to determine the ability of the testing environment to characterize mechanical sensitivity in the paw of mice subject to inflammatory pain. Paw inflammation was induced with an intra plantar injection of carrageenan. Carrageenan solution (50 μL, 1% wt/vol in saline; Sigma-Aldrich, St. Louis, Mo.) was freshly prepared and injected into the plantar surface of the left hindpaw using a Hamilton microsyringe with a 301/2-gauge needle. Control mice were injected with saline (24 QQ, Sigma-Aldrich). Referring to FIG. 11, carrageen treated mice spent 30.1±2.5% of the assay time on the chainmail hammock versus 40.3±3.3% for control mice. (p-value <0.05, two-tailed t-test, n=17 SNI, 16 Sham). These data demonstrate that the percentage of time spent on the chainmail hammock can characterize mechanical hypersensitivity due to peripheral inflammation.

A number of embodiments have been described. Nevertheless, it will be understood that various modifications may be made without departing from the spirit and scope of the invention. For example, some of the steps described above may be order independent, and thus can be performed in an order different from that described.

Other implementations are also within the scope of the following claims.

What is claimed is:

1. A method for characterization of mechanically induced pain experienced by an animal, the method comprising:
exposing the animal to an environment including a first region having a planar surface and a second region having a chainmail structure;
characterizing an interaction of the animal with one or more of the first region of the environment and the second region of the environment; and
determining a characterization of tactile hypersensitivity experienced by the animal based on the characterization of the interaction of the animal with one or more of the first and second regions of the environment.

2. The method of claim 1, in which determining a characterization of the mechanically induced pain experienced by the animal comprises quantitatively characterizing the tactile hypersensitivity experienced by the animal.

3. The method of claim 1, comprising providing the environment, including providing a chainmail hammock for the second region.

4. The method of claim 1, in which characterizing an interaction of the animal comprises determining an amount of time spent by the animal in the second region.

5. The method of claim 1, in which characterizing an interaction of the animal comprises capturing a video of the interaction of the animal with each of the first region and the second region.

6. The method of claim 5, in which characterizing the interaction comprises analyzing the captured video to characterize one or more behaviors of the animal.

7. The method of claim 6, in which analyzing the captured video comprises characterizing a grooming behavior of the animal.

8. The method of claim 5, comprising analyzing the video using a predictive analytics algorithm, based on animal behavior patterns.

9. The method of claim 1, in which characterizing an interaction of the animal comprises characterizes a change in the interaction over a duration of the animal's exposure to the environment.

10. The method of claim 1, in which characterizing an interaction of the animal comprises characterizing one or more of a speed and a direction of the animal's movement in the second region.

11. A method for screening treatments for tactile hypersenstivity, the method comprising:
sequentially exposing each of multiple animals in an injury group to an environment including a first region having a planar surface and a second region having a chainmail structure;
characterizing an average interaction of the animals in the injury group with one or more of the first region of the environment and the second region of the environment; and
treating each of multiple animals in a treatment group with a potential treatment for mechanically induced pain, in which the animals in the treatment group experience mechanical hypersensitivity;
sequentially exposing each of the treated animals in the treatment group to the environment;
characterizing an average interaction of the treated animals in the treatment group with one or more of the first region of the environment and the second region of the environment; and
determining an effectiveness of the potential treatment based on a comparison between the average interaction of the animals in the injury group and the average interaction of the treated animals in the treatment group.

12. A system for characterization of neuropathic pain experienced by an animal, the system comprising:
an enclosed test environment having a first region and a second region adjacent the first region,
the first region having a planar surface, and
the second region having a chainmail structure;
one or more cameras positioned such that the entire first region and the entire second region are in a field of view of the one or more cameras; and
a computing device including one or more processors coupled to a memory and configured to analyze images obtained by the one or more cameras and to determine a characterization of neuropathic pain experienced by an animal in the enclosed test environment based on the analysis of the images.

13. The system of claim 12, in which the chainmail structure comprises a chainmail hammock.

14. The system of claim 12, in which the enclosed testing environment has a third region including a cold plate.

15. The system of claim 14, in which the third region is adjacent the first region.

16. The system of claim 12, in which the one or more processors are configured to apply a predictive analytics algorithm in the analysis of the images.
